(19) United States
(12) Patent Application Publication
(10) Pub. No.: US 2020/0026923 A1
(43) Pub. Date: Jan. 23, 2020

(54) SYSTEM FOR AUTOMATICALLY DETECTING NEW HOME CONSTRUCTION PROGRESS

(71) Applicant: Builder Digital Solutions, Inc., Fenton, MI (US)

(72) Inventor: Gordon J. Henderson, Fenton, MI (US)

(21) Appl. No.: 16/512,844

(22) Filed: Jul. 16, 2019

Related U.S. Application Data
(60) Provisional application No. 62/701,160, filed on Jul. 20, 2018.

(51) Int. Cl. G06K 9/00; G06K 9/62; G06F 16/51; H04L 12/58

(52) U.S. Cl. CPC G06K 9/00691; G06K 9/00771; H04L 51/04; G06F 16/51; G06K 9/6267

(57) ABSTRACT

A system for automatically detecting new home construction progress is provided. The system includes an image classification controller that sends the digital photograph to a first digital image classification model which determines a first prediction score associated with a first physical attribute identifier. The build task test engine controller determines a first build task that has been completed in the new home using a first physical attribute identifier, a first prediction score, and first build task completion tests. The build task notification controller generates an electronic message that indicates the first build task has been completed.

### CROSS-REFERENCE TO RELATED APPLICATIONS

This application claims priority to U.S. Provisional Patent Application No. 62/701,160 filed on Jul. 20, 2018, the entire contents of which are hereby incorporated by reference herein.

### BACKGROUND

A purchase of a new home is one of the largest financial investments that a person makes in their lifetime. As a result, new home buyers are particularly interested in knowing the current home construction progress of their new home. If a home buyer lives in the area of their new home, and if they have sufficient time, they may visit the construction site in order to check up on the home construction progress. However, if the home buyer is very busy, they may not visit the construction site to be updated on the home construction progress. Further, if a new home buyer lives outside of the area of their new home, they may not visit the construction site to be updated on the home construction progress.

The inventor herein has recognized that it would be desirable to have a new system that automatically detects new home construction progress. In particular, the new system automatically analyzes the content of recent photographs of the home to determine present physical attribute identifiers, and utilizes build task completion tests that review previously determined physical attribute identifiers and previously completed build tasks to reliably determine that a new build task is completed, and to notify a new home buyer of the completed new build task. The notification of completed build tasks will create a more engaging and personal experience for new home buyers which in turn provides a deep emotional connection to their new home and community. The notification of completed build tasks also benefits new home builders by providing a more deeply connected customer that is less likely to cancel a new home construction contract and who will promote the builder to their friends and family. Additionally, builders are able to leverage the intelligence gained by the notification of build tasks in order to eliminate waste and delays in the home construction process.

### SUMMARY

A system for automatically detecting new home construction progress in accordance with an exemplary embodiment is provided. The system includes at least one computer having an image intake processor, an image classification controller, a build task test engine controller, and a build task notification controller. The image intake processor receives a digital photograph of a new home and photograph attribute data associated with the digital photograph. The photograph attribute data includes a photograph identifier, and a home identifier for the new home. The image classification controller sends the digital photograph to a first digital image classification model which determines a first prediction score associated with a first physical attribute identifier. The first prediction score indicates a probability that the digital photograph illustrates a first physical attribute corresponding to the first physical attribute identifier. The build task test engine controller determines a first build task that has been completed in the new home using the first physical attribute identifier, the first prediction score, and first build task completion tests. The build task notification controller generates an electronic message that indicates the first build task has been completed.

### BRIEF DESCRIPTION OF THE DRAWINGS

FIG. 1 is a schematic of a system for automatically detecting new home construction progress in accordance with an exemplary embodiment;

FIG. 2 is a block diagram of a computer utilized in the system of FIG. 1;

FIG. 3 is a block diagram of a relational database management system utilized in the computer of FIG. 2;

FIG. 4 is a block diagram of a new home builder table, a subdivision table, a homesite table, a photograph table, and a users table utilized in the relational database management system of FIG. 3;

FIG. 5 is a block diagram of a photograph table, a labels table, a label types table, and a digital image classification models table utilized in the relational database management system of FIG. 3;

FIG. 6 is a block diagram of a build task table, a test conditions table, a build task completion test table, a labels table, and a build task occurrence table utilized in the relational database management system of FIG. 3;

FIG. 7 is a block diagram of a users table, a follows table, a homesite table, a sendqueue table, a build task occurrence table utilized in the relational database management system of FIG. 3;

FIG. 8 is a schematic of an exemplary build task table utilized in the relational database management system of FIG. 3;

FIG. 9 is a schematic of an exemplary test conditions table utilized in the relational database management system of FIG. 3;

FIG. 10 is a schematic of an exemplary build task completion test table utilized in the relational database management system of FIG. 3;

FIG. 11 is a schematic of an exemplary labels table utilized in the relational database management system of FIG. 3;

FIG. 12 is a schematic of an exemplary build task occurrence table utilized in the relational database management system of FIG. 3;

FIGS. 13-14 are flowcharts of a method performed by an image intake processor in the computer of FIG. 2;

FIGS. 15-16 are flowcharts of a method performed by an image classification controller in the computer of FIG. 2;

FIGS. 17-19 are flowcharts of a method performed by a build task test engine controller in the computer of FIG. 2;

FIGS. 20-21 are flowcharts of a method performed by a build task notification controller in the computer of FIG. 2; and

FIG. 22 is a schematic of an exemplary digital photograph utilized to determine new home construction progress.

### DETAILED DESCRIPTION

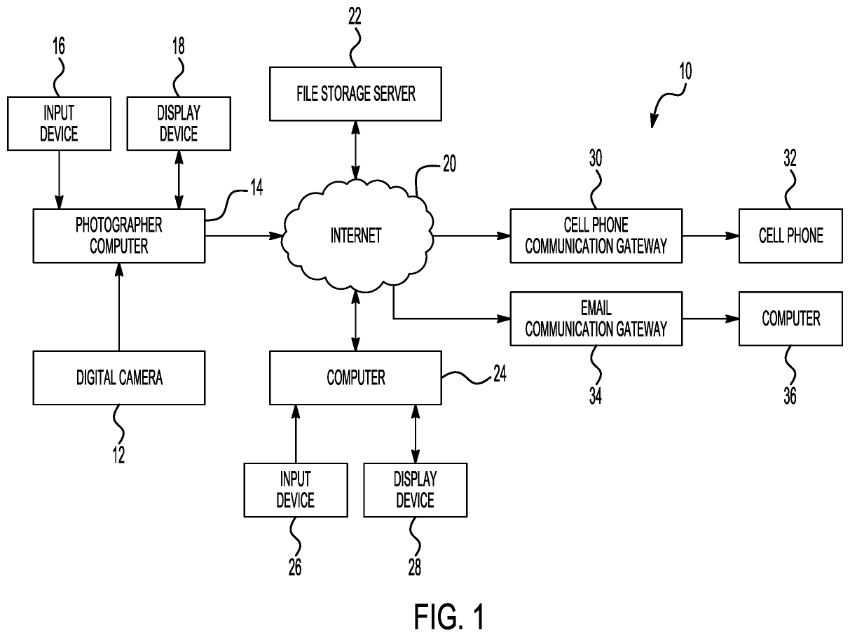

Referring to FIG. 1, a system 10 for automatically detecting a new home construction progress in accordance with an exemplary embodiment is illustrated. The system 10 includes a digital camera 12, a photographer computer 14, an input device 16, a display device 18, the Internet 20, a file storage server 22, a computer 24, an input device 26, a display device 28, a cell phone communication gateway 30, a cell phone 32, an email communication gateway 34, and a computer 36.

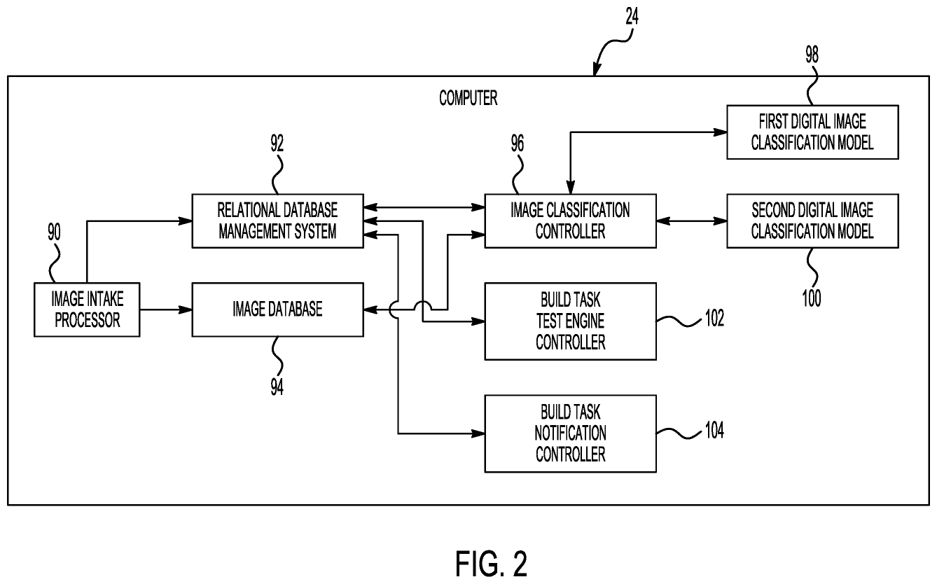

An advantage of the system 10 is that the system 10 utilizes a computer 24 with the build task test engine controller 102 (shown in FIG. 2) that automatically determines a build task that has been completed in the new home by analyzing a digital photograph and utilizing a physical attribute identifier, a prediction score, and build task completion tests. In particular, the computer 24 automatically analyzes the content of recent digital photographs of the home to determine present physical attribute identifiers, and utilizes the build task completion tests to review previously determined physical attribute identifiers and previously completed build tasks to reliably determine that a new build task has been completed. For example, if a builder was building 1,000 homes and ten digital photographs were taken of each home each week, resulting in 10,000 digital photographs to be analyzed each week, the computer 24 could accurately determine the new build tasks completed within the 1,000 homes within a couple hours. As a result, the computer 24 determines the completion of a new build tasks associated with a new home more efficiently and accurately than any known system. Further, the computer 24 automatically generates an electronic message that indicates that the new build task has been completed, and sends the electronic message to authorized recipients.

For purposes of understanding, a physical attribute identifier is a word or number that identifies a physical attribute of a physical object or objects illustrated in a digital photograph.

A digital photograph illustrates a physical attribute by having an image of the physical attribute therein.

A build task is a task that is performed during a construction of a new home. Exemplary build tasks include an installation of a home foundation, an installation of a home framing, an installation of electrical wiring, an installation of the HVAC system, an installation of drywall, an installation of appliances such as a refrigerator, a dishwasher, a stove, and an oven, and an installation of flooring.

A design feature/strategy of the system 10 is a use of digital image classification models/algorithms. Using a library of in-progress construction digital photographs, numerous digital photographs were labeled with key content metadata indicating physical attributes that were illustrated in the digital photographs. Then, using deep convolutional neural network machine learning algorithms, the digital image classification models were developed to detect and predict a content of physical attributes within construction digital photographs, such as: (i) interior versus exterior of a home in progress, (ii) framing, (iii) insulation, (iv) kitchen photos, (v) appliances such as a refrigerator, a dishwasher, a stove, and an oven, (vi) counter tops and cabinets, (vii) drywall, (viii) painting and trim.

Referring to FIG. 1, the components of the system 10 will now be explained in greater detail.

The digital camera 12 is utilized by a photographer to capture digital photographs of a new home. The digital camera 12 operably communicates with the photographer computer 14 for uploading digital photographs from the digital camera 12 to the photographer computer 14.

The photographer computer 14 operably communicates with the input device 16, the display device 18, the digital camera 12, and the Internet 20. The photographer computer 14 uploads and stores the digital photographs to the file storage server 22 utilizing the Internet 20. A photographer utilizing the photographer computer 14 inputs a photograph identifier, a home identifier, a photograph date-time stamp, and a photographer identifier utilizing the input device 16 that is received by the photographer computer 14. The photographer computer 14 uploads and stores the photograph identifier, the home identifier, the photograph date-time stamp, and the photographer identifier in the file storage server 22, utilizing the Internet 20.

The Internet 20 operably communicates with the photographer computer 14, the file storage server 22, the computer 24, the cell phone communication gateway 30, and e-mail communication gateway 34, and allows communication between the foregoing devices.

The file storage server 22 operably communicates with the Internet 20 and is utilized to store digital photographs that are uploaded from the photographer computer 14. The file storage server 22 further stores a home identifier, a photograph date and time, and a photographer identifier associated with each digital photograph.

Referring to FIGS. 1 and 2, the computer 24 is provided to automatically detect new home construction progress in the digital photographs received from the file storage server 22, and to generate electronic messages indicating the new home construction progress that are sent to desired recipients. The computer 24 operably communicates with the Internet 20, the input device 26 and the display device 28. The computer 24 further operably communicates with the file storage server 22, the cell phone communication gateway 30, and the email communication gateway 34, utilizing the Internet 20.

The computer 24 includes an intake image processor 90, a relational database management system 92, an image database 94, an image classification controller 96, a first digital image classification model 98, a second digital image classification model 100, a build task test engine controller 102, and a build task notification controller 104. In an exemplary embodiment, the image classification controller 96, the first digital image classification model 98, the second digital image classification model 100, the build task test engine controller 102, and the build task notification controller 104 are software applications executed within the computer 24. The computer 24 can comprise one or more computer devices that operably communicate with each other to execute the image classification controller 96, the first digital image classification model 98, the second digital image classification model 100, the build task test engine controller 102, and the build task notification controller 104.

The image intake processor 90 receives a digital photograph of the new home and the photograph attribute data from the file storage server 22. The photograph attribute data includes a photograph identifier, the home identifier, a photograph date-time stamp, and a photographer identifier. The image intake processor 90 stores the digital photograph in an image database 94. The image intake processor 90 stores the photograph attribute data in a record in a photograph table 140 in the relational database management system 92.

Referring to FIGS. 2-7, the relational database management system 92 is utilized to store data in the tables that are utilized by the computer 24 for detecting new home construction progress in the digital photographs. The relational database management system 92 includes a photograph table 140, a homesite table 142, a subdivision table 144, a new home builder table 146, a users table 148, a labels table 150, a label types table 152, a digital image classification models table 154, a build task completion test table 156, a test conditions table 158, a build task table 160, a build task occurrence table 162, a follows table 164, and a sendqueue table 166.

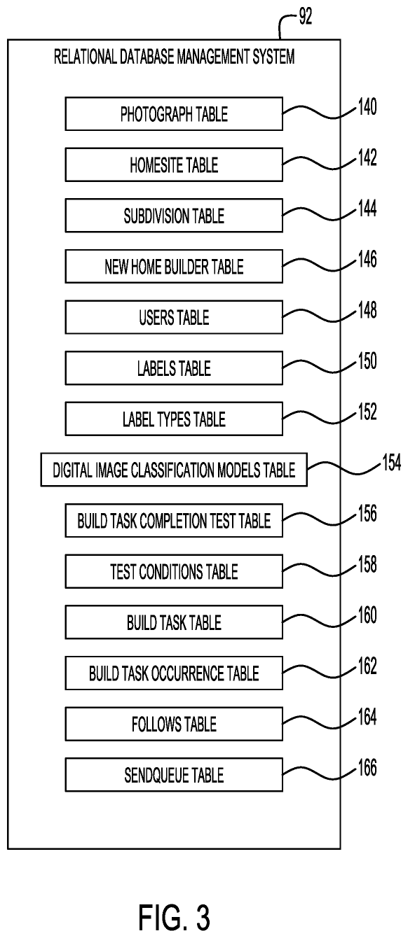

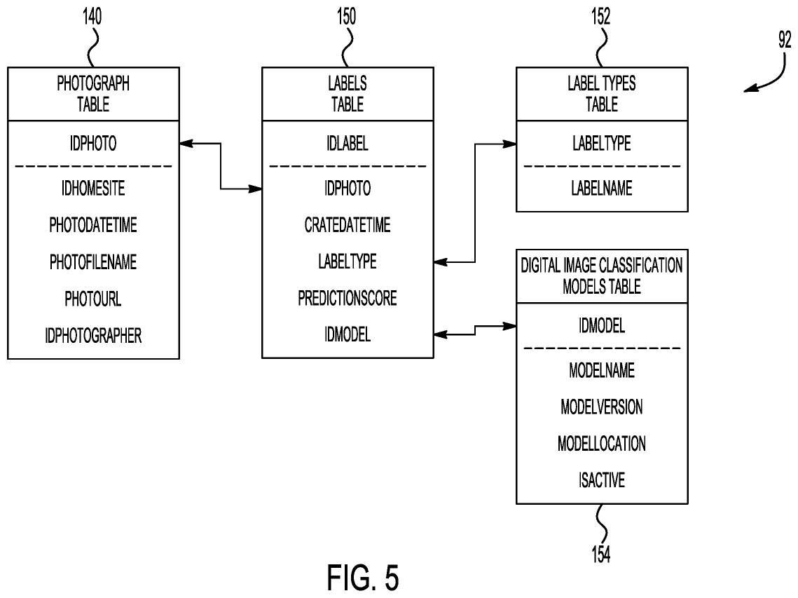

Referring to FIGS. 3 and 5, the photograph table 140 includes a plurality of records with each record being associated with a specific digital photograph. Each record in the photograph table 140 includes a unique photograph identifier in an IDPHOTO field, a home identifier in a IDHOMESITE field, a photograph date-time stamp in a PHOTODATETIME field, a photograph filename in a PHOTOFILENAME field, a photograph universal resource locator in a PHOTOURL field, and a photographer identifier in IDPHOTOGRAPHER field. A record in the photograph table 140 is linked to a record in the labels table 150 when both records have an identical photograph identifier in the IDPHOTO field. Further, a record in the photograph table 140 is linked to a record in the users table 148 when the IDPHOTOGRAHPER field in the photograph table matches the IDUSER field in the users table.

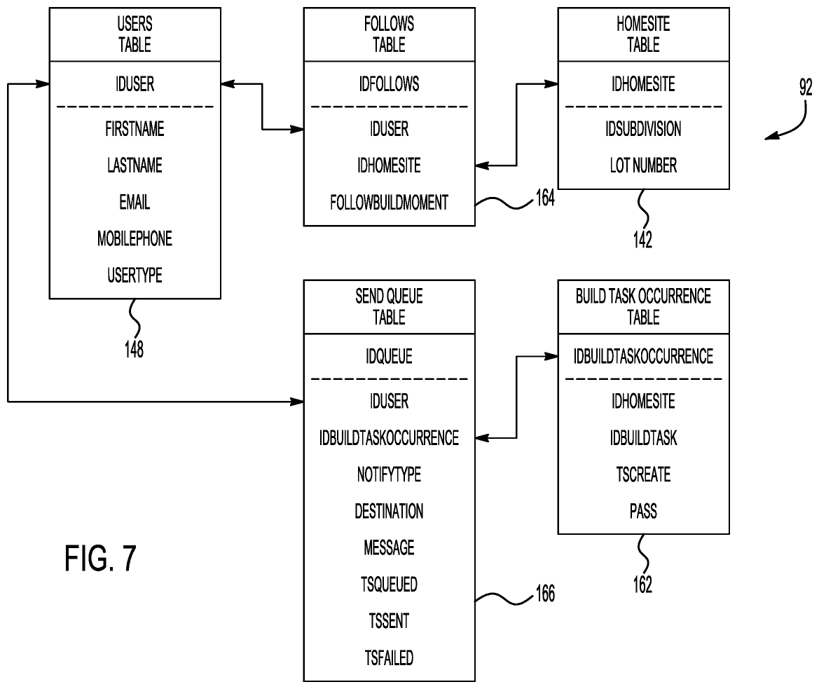

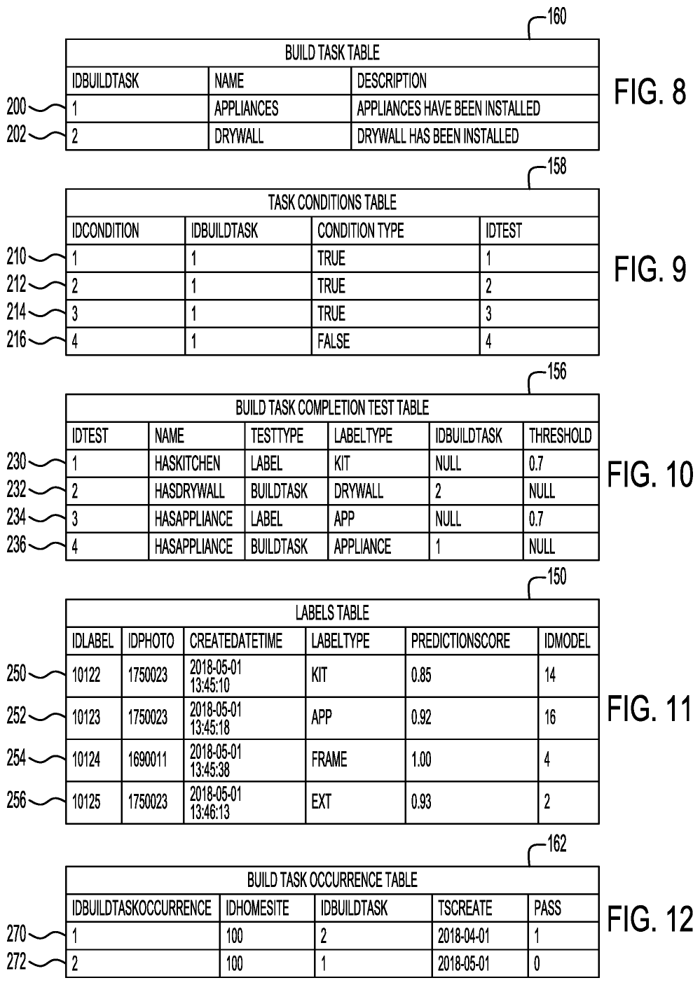

Referring to FIGS. 3 and 7, the homesite table 142 includes a plurality of records with each record being associated with a specific new home. Each record in the homesite table 142 includes a unique home identifier in an IDHOMESITE field, a subdivision identifier in an IDSUBDIVISION field, and a lot number in a LOT NUMBER field. A record in the homesite table 142 is linked to a record in the follows table 164 when both records have an identical home identifier in the IDHOMESITE field.

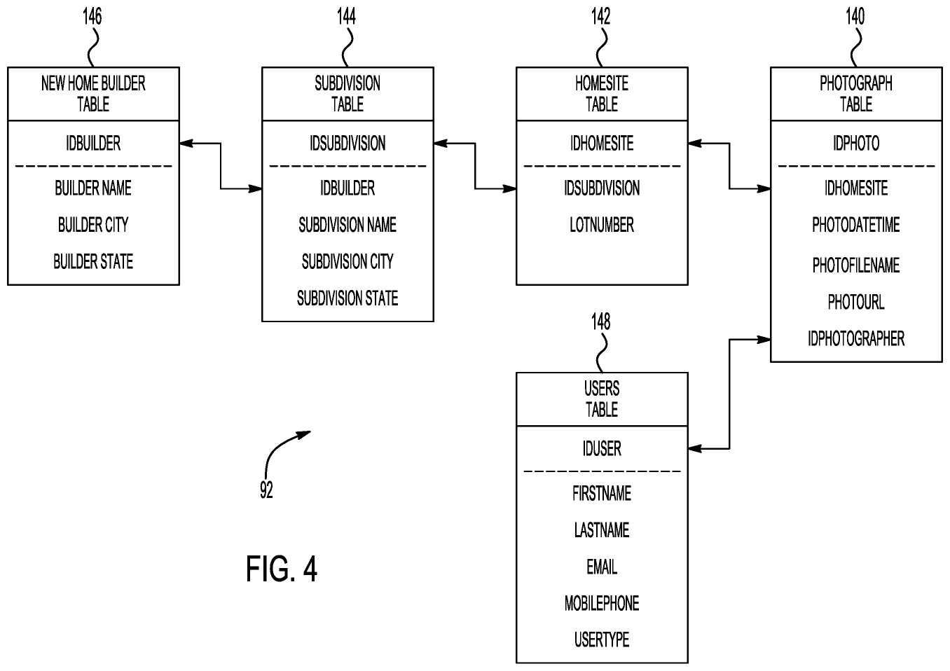

Referring to FIGS. 3 and 4, the subdivision table 144 includes a plurality of records with each record being associated with a specific subdivision. Each record in the subdivision table 144 includes a unique subdivision identifier in an IDSUBDIVISION field, a builder identifier in an IDBUILDER field, a subdivision name in a SUBDIVISION NAME field, a subdivision city identifier in a SUBDIVISION CITY field, and a subdivision state identifier in a SUBDIVISION STATE field. A record in the subdivision table 144 is linked to a record in the new home builder table 146 when both records have an identical builder identifier in the IDBUILDER field. Further, a record in the subdivision table 144 is linked to a record in the HOMESITE table 142 when both records have an identical subdivision identifier in the IDSUBDIVISION field.

Referring to FIGS. 3 and 4, the new home builder table 146 includes a plurality of records with each record being associated with a specific home builder. Each record in the new home builder table 146 includes a unique builder identifier in an IDBUILDER field, the builder name in a BUILDER NAME field, a builder city identifier in a BUILDER CITY field, a builder state identifier in a BUILDER STATE field. A record in the new home builder table 146 is linked to a record in the subdivision table 144 when both records have an identical builder identifier in the IDBUILDER field.

Referring to FIGS. 3 and 4, the users table 148 includes a plurality of records with each record being associated with a specific user of the system 10. Each record in the users table 148 includes a unique user identifier in an IDUSER field, a first name of the user in a FIRSTNAME field, a last name of the user in a LASTNAME field, an email address in an EMAIL field, mobile phone number in a MOBILEPHONE field, a user type in a USERTYPE field. The user type is used to distinguish different types of users such as photographers, home buyers, builder staff, etc. A record in the users table 148 is linked to a record in the photograph table 140 when both records have an identical user identifier in the IDUSER field.

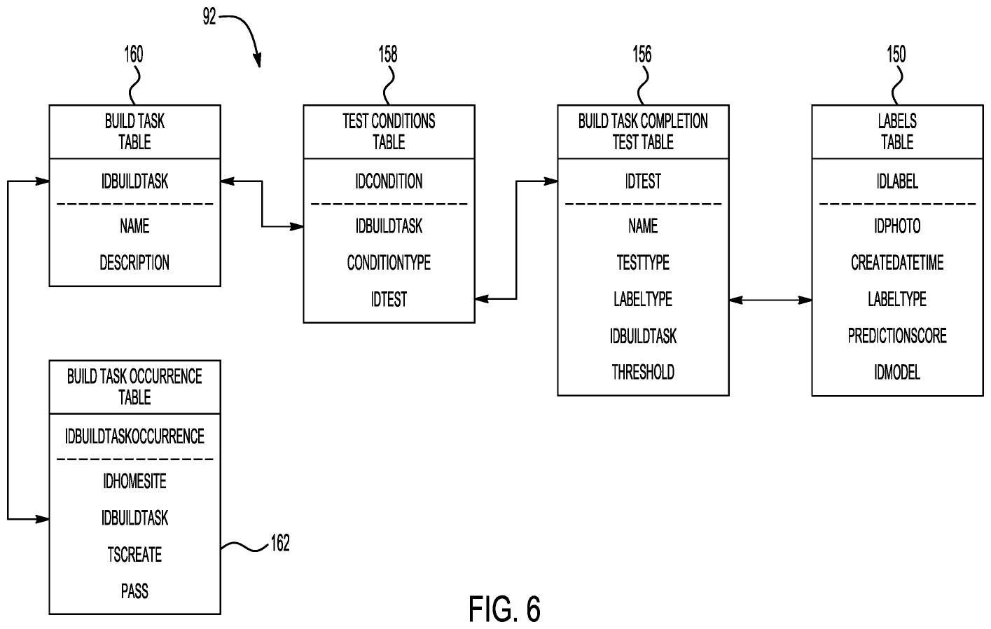

Referring to FIGS. 3 and 5, the labels table 150 includes a plurality of records with each record being associated with a specific physical attribute (identified in the LABELTYPE field) and a prediction score indicating a probability that the physical attribute is illustrated in a specific digital photograph. Each completed record in the labels table 150 includes a unique label identifier in ID label field, a photograph identifier in an IDPHOTO field, a creation date and time in a CREATEDATETIME field, a label type identifier in a LABELTYPE field, a prediction score in a PREDICTIONSCORE field, and a digital image classification model identifier in an IDMODEL field. The label type identifier indicates a specific physical attribute associated with the home construction progress. The specific physical attribute could be any physical attribute of a home including for example a kitchen, framing, exterior, drywall, and electrical fixtures, etc. The prediction score indicates a probability that the specific physical attribute has been identified in the digital photograph. Typically the prediction score is in a scale from 0-1, wherein a score of 0 indicates that there is a 0% probability that the specific physical attribute is illustrated in the digital photograph, a score of 0.7 indicates that there is a 70% probability that the physical attribute is illustrated in the digital photograph, and a score of 1 indicates that there is a 100% probability that the physical attribute is illustrated in the digital photograph. Referring to FIG. 6, a record in the labels table 150 is linked to a record in the build task completion test table 156 when both records have an identical label type identifier in the LABELTYPE field. Referring to FIG. 5, a record in the labels table 150 is linked to a record in the photograph table 140 when both records have an identical photograph identifier in the IDPHOTO field. Further, a record in the labels table 150 is linked to a record in the label types table 152 when both records have an identical label type identifier in the LABELTYPE field. Further, a record in the labels table 150 is linked to a record in the digital image classification model table 154 when both records have an identical digital image classification model identifier in the IDMODEL field.

Referring to FIG. 11, an exemplary labels table 150 is illustrated. The labels table 150 includes records 250, 252, 254, 256. The record 250 includes a label identifier of 10122 in the IDLABEL field, a photograph identifier of 1750023 in the IDPHOTOFIELD, a creation date and time of 2018-05-01 13:45:10 in the CREATEDATETIME field, a label type identifier of KIT (referring to kitchen) in the LABELTYPE field, a prediction score of 0.85 in the PREDICTIONSCORE field, and a digital image classification model of 14 in the IDMODEL field.

The record 252 includes a label identifier of 10123 in the IDLABEL field, a photograph identifier of 1750023 in the IDPHOTOFIELD, a creation date and time of 2018-05-01 13:45:18 in the CREATEDATETIME field, a label type identifier of APP (referring to appliance) in the LABELTYPE field, a prediction score of 0.92 in the PREDICTIONSCORE field, and a digital image classification model of 16 in the IDMODEL field.

The record 254 includes a label identifier of 10124 in the IDLABEL field, a photograph identifier of 1690011 in the IDPHOTOFIELD, a creation date and time of 2018-05-01 13:45:38 in the CREATEDATETIME field, a label type identifier of FRAME (referring to framing of a home) in the LABELTYPE field, a prediction score of 1.00 in the PREDICTIONSCORE field, and a digital image classification model of 4 in the IDMODEL field.

The record 256 includes a label identifier of 10125 in the IDLABEL field, a photograph identifier of 1730023 in the IDPHOTOFIELD, a creation date and time of 2018-05-01 13:46:13 in the CREATEDATETIME field, a label type identifier of EXT (referring to an exterior of a home) in the LABELTYPE field, a prediction score of 0.93 in the PREDICTIONSCORE field, and a digital image classification model of 2 in the IDMODEL field.

Referring to FIGS. 3 and 5, the label types table 152 includes a plurality of records with each record being a label type associated with a specific physical attribute. Each record in the label types table 152 includes a unique label type identifier in a LABELTYPE field, and a label name and a LABELNAME field. A record in the label types table 152 is linked to a record in the labels table 150 when both records having an identical label type identifier in the LABELTYPE field.

Referring to FIGS. 3 and 5, the digital image classification models table 154 includes a plurality of records with each record being associated with a specific digital image classification model. Each record in the digital image classification models table 154 includes a unique digital image classification model identifier in an IDMODEL field, a digital image classification model name in a MODEL NAME field, a model version in a MODEL VERSION field, a model location in a MODEL LOCATION field, and an active flag in an ISACTIVE field. The active flag indicates whether the specific digital image classification model is active for use or not. A record in the digital image classification models table 154 is linked to a record in the labels table 150 when both records have an identical digital image classification model identifier in the IDMODEL field.

Referring to FIGS. 3 and 6, the build task completion test table 156 includes a plurality of records with each record being associated with a specific test for determining whether a physical attribute is illustrated in a digital photograph. Each record in the build task completion test table 156 includes a unique test identifier in an IDTEST field, a test name in a NAME field, a test type identifier in a TESTTYPE field, a label type identifier in a LABELTYPE field, a build task identifier in an IDBUILDTASK field, and a threshold value in a THRESHOLD field. The threshold value corresponds to a threshold prediction score wherein if a prediction score is greater than or equal to the threshold value, then the build task completion test recognizes that the physical attribute (identified in the LABELTYPE field) is illustrated in the digital photograph. A record in the build task completion test table 156 is linked to a record in the labels table 150 when both records have an identical label type identifier in the LABELTYPE field. Further, a record in the build task completion test table 156 is linked to a record in the test conditions table 158 when both records have an identical test identifier in the IDTEST field. Further, a record in the build task completion test table 156 is linked to a record in the build task occurrence table 162 when both records have an identical build task identifier in the IDBUILDTASK field.

Referring to FIG. 10, an exemplary build task completion test table 156 that contains tests for determining whether appliances have been installed in a home is provided. The build task completion test table 156 includes records 230, 232, 234, 236 each corresponding to a specific test that must be passed in order to determine that appliances have been installed in the home.

The record 230 includes a test identifier of 1 in the IDTEST field, a test name of HASKITCHEN in the name field, a test type of LABEL in the TESTTYPE field, a label type identifier of KIT (referring to kitchen) in the LABELTYPE field, a null value in the IDBUILDTASK field, a threshold value of 0.7 in the THRESHOLD field.

The record 232 includes a test identifier of 2 in the IDTEST field, a test name of HASDRYWALL in the name field, a test type of BUILDTASK (indicating that data from the build task occurrence table 162 will be utilized in the test) in the TESTTYPE field, a label type identifier of DRYWALL (referring to drywall) in the LABELTYPE field, a value of 2 in the IDBUILDTASK field, a threshold value of null in the THRESHOLD field. The threshold value of NULL in the THRESHOLD field means that the threshold value is irrelevant for the test in record 232.

The record 234 includes a test identifier of 3 in the IDTEST field, a test name of HASAPPLIANCE in the name field, a test type of LABEL in the TESTTYPE field, a label type identifier of APP (referring to appliance) in the LABELTYPE field, a null value in the IDBUILDTASK field, a threshold value of 0.7 in the THRESHOLD field.

The record 236 includes a test identifier of 4 in the IDTEST field, a test name of HASAPPLIANCE in the name field, a test type of BUILDTASK in the TESTTYPE field, a label type identifier of APPLIANCE (referring to appliance) in the LABELTYPE field, a value of 1 in the IDBUILDTASK field, a threshold value of NULL in the THRESHOLD field.

Referring to FIGS. 3 and 6, the test conditions table 158 includes a plurality of records with each record being associated with a specific test condition (e.g., true or false condition) associated with a specific test in the build task completion test table 156 for determining whether a physical attribute is illustrated in a digital photograph. Each record in the test conditions table 158 includes a unique condition identifier in an IDCONDITION field, a build task identifier in an IDBUILDTASK field, a condition type in a CONDITIONTYPE field, and a test identifier in an IDTEST field. A record in the test conditions table 158 is linked to a record in the build task completion test table 156 when both records have an identical test identifier in the IDTEST field. Further, a record in the test conditions table 158 is linked to a record in the build task table 160 when both records have an identical build task identifier in the IDBUILDTASK field.

Referring to FIG. 9, an exemplary test conditions table 158 that contains test conditions for the tests in the build task completion test table 156 is illustrated. The test conditions table 158 includes records 210, 212, 214, 216 each corresponding to a specific test condition for a specific test in the build task completion test table 156.

The record 210 includes a condition identifier of 1 in the IDCONDITION field, a build task identifier of 1 in the IDBUILDTASK field, a condition type of TRUE in the condition type field, and a test identifier of 1 in the IDTEST field.

The record 212 includes a condition identifier of 2 in the IDCONDITION field, a build task identifier of 1 in the IDBUILDTASK field, a condition type of TRUE in the condition type field, and a test identifier of 2 in the IDTEST field.

The record 214 includes a condition identifier of 3 in the IDCONDITION field, a build task identifier of 1 in the IDBUILDTASK field, a condition type of TRUE in the condition type field, and a test identifier of 3 in the IDTEST field.

The record 216 includes a condition identifier of 4 in the IDCONDITION field, a build task identifier of 1 in the IDBUILDTASK field, a condition type of FALSE in the condition type field, and a test identifier of 4 in the IDTEST field.

A brief description of the interaction of the test conditions in the test condition table 158, and the tests in the build task completion test table 156 will be explained. The test conditions in the test condition table 158 and the tests in the build task completion test table 156 define the build task completion tests for determining whether a build task of installing appliances has been completed. The illustrated test conditions in records 210, 212, 214, 236 illustrate the test conditions associated with the build task identifier 1 (shown in the build task table 160) for determining that appliances have been installed. The records 210, 212, 214, 236 indicate the test identifiers (1, 2, 3, 4) that will be performed and which are associated with the condition types (TRUE, TRUE, TRUE, FALSE) respectively. For the build task corresponding to the installation of appliances to be detected, the tests 1, 2, 3, 4 in the build task completion test table 156 must have the following logical results TRUE, TRUE, TRUE, FALSE, respectively, and the build task occurrence table 162 must not indicate that this specific build task has been previously detected/completed. In other words, for determining whether a build task of installing appliances has been completed, the following tests must be passed: (i) the labels table 150 must have an associated label record having a LABELTYPE of KIT that indicates a digital image of the home illustrated a kitchen therein, (ii) the build task occurrence table 162 must have an associated record that indicates drywall was installed in the home, (iii) the labels table 150 must have an associated label record having a LABELTYPE of APP that indicates a digital image of the home illustrated appliances therein, and (iv) the build task occurrence table 162 must not have an associated record indicating appliances were previously installed.

Referring to FIGS. 3 and 6, the build task table 160 includes a plurality of records with each record being associated with a specific build task. Each record in the build task table 160 includes a unique build task identifier in an IDBUILDTASK field, a build task name in a NAME field, and a description in a DESCRIPTION field. A record in the build task table 160 is linked to a record in the test conditions table 158 when both records have an identical build task identifier in the IDBUILDTASK field. Further, a record in the build task table 160 is linked to a record in the build task occurrence table 162 when both records have an identical build task identifier in the IDBUILDTASK field.

Referring to FIG. 9, an exemplary build task table 160 that contains a list of possible build tasks associated with new home construction progress is illustrated. The build task table 160 includes records 200, 202 each corresponding to a specific build task.

The record 200 includes a build task identifier of 1 in the IDBUILDTASK field, a name of APPLIANCES in the name field, and a description of APPLIANCES HAVE BEEN INSTALLED in the description field.

The record 202 includes a build task identifier of 2 in the IDBUILDTASK field, a name of DRYWALL in the name field, and a description of DRYWALL HAS BEEN INSTALLED in the description field.

Referring to FIGS. 3 and 6, the build task occurrence table 162 includes a plurality of records with each record being associated with a specific build task that has been detected for a new home. Each record in the build task occurrence table 162 includes a unique build task occurrence identifier in an IDBUILDTASKOCCURRENCE field, a home identifier in an IDHOMESITE field, a build task identifier in an IDBUILDTASK field, a timestamp in a TSCREATE field, and a pass value in a PASS field. A pass value of 1 indicates that tests for a specific build task test were previously run and completion of a specific build task was detected. A pass value of 0 indicates that tests for a specific build task test were previously run but completion of a specific build task was not detected. A record in the build task occurrence table 162 is linked to a record in the build task table 160 when both records have an identical build task identifier in the IDBUILDTASK field.

Referring to FIG. 9, an exemplary build task occurrence table 162 is illustrated. The build task occurrence table 162 includes records 270, 272 each corresponding to a specific detected build task that has been completed in a new home.

The record 270 includes a build task occurrence identifier of 1 in the IDBUILDTASKOCCURRENCE field, a home identifier of 100 in the IDHOMESITE field, a build task identifier of 2 in the IDBUILDTASK field, a timestamp of 2018-04-01 in the TSCREATE field, and a pass value of 1 in the PASS field.

The record 272 includes a build task occurrence identifier of 2 in the IDBUILDTASKOCCURRENCE field, a home identifier of 100 in the IDHOMESITE field, a build task identifier of 1 in the IDBUILDTASK field, a timestamp of 2018-05-01 in the TSCREATE field, and a pass value of 1 in the PASS field.

Referring to FIGS. 3 and 7, the follows table 164 includes a plurality of records with each record being associated with a specific recipient to be notified when a build task is completed. Each record in the follows table 164 includes a unique follows identifier in an IDFOLLOWS field, a user identifier in an IDUSER field, a home identifier in a IDHOMESITE field, and a follow build moment flag in a FOLLOW BUILD MOMENT field. A record in the follows table 164 is linked to a record in the home site table 142 when both records have an identical home identifier in the IDHOMESITE field. Further, a record in the follows table 164 is linked to a record in the users table 148 when both records have an identical user identifier in the IDUSER field.

The sendqueue table 166 includes a plurality of records with each record being associated with a specific electronic message that is queued to be sent to a person identified in the users table 148. Each record in the sendqueue table 166 includes a unique queue identifier in an IDQUEUE field, a user identifier in an IDUSER field, a build task occurrence identifier in an IDBUILDTASKOCCURRENCE field, a notification type for electronic message in a NOTIFYTYPE field, a destination in a DESTINATION field, a message in a MESSAGE field, a timestamp for an electronic message in a TSQUEUED field, a sent timestamp in a TSSENT field, and a failure timestamp in a TSFAILED field.

Referring to FIG. 2, the image database 94 is provided to store digital photographs received by the computer 24 therein. The image database 94 operably communicates with the image intake processor 90 and the image classification controller 96.

The image classification controller 96 sends each digital photograph to the first and second digital image classification models 98, 100 to determine whether the respective digital photograph illustrates first and second physical attributes, respectively, therein. For purposes of simplicity, only two digital image classification models are illustrated. It should be understood that a plurality of additional digital image classification models could be utilized for detecting a plurality of additional physical attributes in digital photographs.

For example, the image classification controller 96 sends a digital photograph to the first digital image classification model 98. The first digital image classification model 98 generates a first prediction score which indicates a probability that the digital photograph illustrates a first physical attribute therein, and returns a first physical attribute identifier and the first prediction score to the image classification controller 96. The image classification controller 96 stores a first label record in a labels table 150 (shown in FIG. 3) which includes a first label identifier, a first label creation date, the first physical attribute identifier, the first prediction score, and a first digital image classification model identifier. The first prediction score indicates a probability that the digital photograph illustrates a first physical attribute identified by the first physical attribute identifier.

Further, for example, the image classification controller 96 sends a digital photograph to the second digital image classification model 100. The second digital image classification model 100 generates a second prediction score which indicates a probability that the digital photograph illustrates a second physical attribute therein, and returns a second physical attribute identifier and the second prediction score to the image classification controller 96. The image classification controller 96 stores a second label record in the labels table 150 (shown in FIG. 3) which includes a second label identifier, a second label creation date, the second physical attribute identifier, the second prediction score, and a second digital image classification model identifier. The second prediction score indicates a probability that the digital photograph illustrates a second physical attribute identified by the second physical attribute identifier.

The build task test engine controller 102 determines that a build task has been completed in the new home utilizing physical attribute identifiers, prediction scores, and build task completion tests. The build task test engine controller 102 operably communicates with the relational database management system 92.

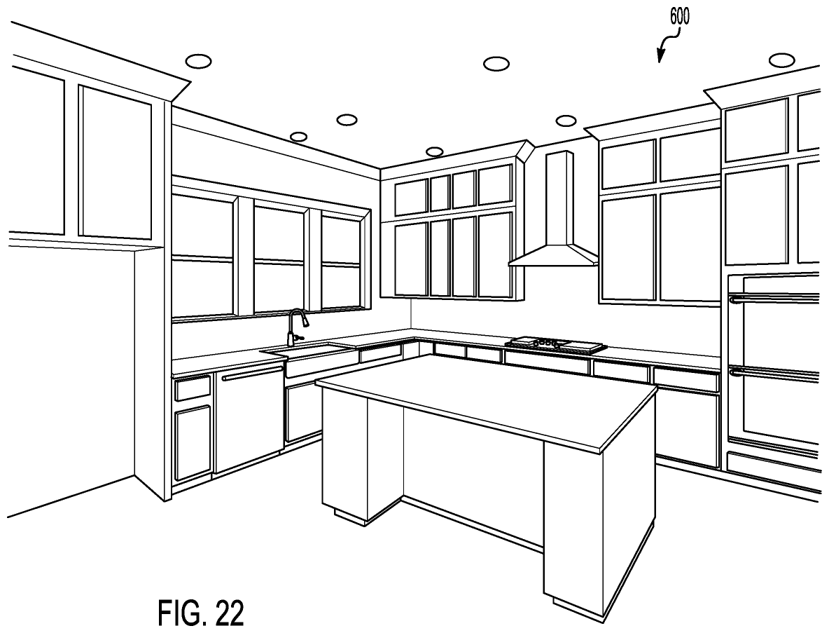

Referring to FIGS. 2, 10, and 12, a simplified description of the operation of the build task test engine controller 102 will be provided below. In an exemplary embodiment, the build task completion tests include first, second, third, and fourth tests in the build task completion test table 156 (shown in FIG. 10) associated with the digital photograph 600 shown in FIG. 22.

In the first test (e.g., record 230 in the build task completion test table 156) associated with a first physical attribute identifier (e.g., LABELTYPE=KIT), the build task test engine controller 102 compares a first prediction score (stored in a label record associated with the home identifier) to a first threshold score (e.g., 0.7). The first test is passed when the first prediction score is greater than the first threshold score, indicating that a kitchen was detected in the digital photograph 600.

In the second test (e.g., record 232 in the build task completion test table 156), the build task test engine controller 102 determines whether the build task occurrence table 162 has a first build task occurrence record 270 indicating a first build task (e.g., LABELTYPE=DRYWALL) was previously completed. The second test is passed when the build task occurrence table 162 has the first build task occurrence record 270 indicating the first build task was previously completed.

In the third test (e.g., record 234 in the build task completion test table 156) associated with a second physical attribute identifier (e.g., LABELTYPE=APP), the build task test engine controller 102 compares a second prediction score (stored in a label record associated with the home identifier) to a second threshold score (e.g., 0.7). The third test is passed when the second prediction score is greater than the second threshold score, indicating that an appliance was detected in the digital photograph 600.

In the fourth test (e.g., record 236 in the build task completion test table 156), the build task test engine controller 102 determines whether the build task occurrence table 162 does not have a second build task occurrence record indicating a second build task (e.g., LABELTYPE=APPLIANCE indicating appliance installation) that was previously completed. This is due to the fact that the CONDITIONTYPE in the test conditions table 158 for the fourth test is FALSE. The fourth test is therefore passed when the build task occurrence table 162 does not have a second build task occurrence record indicating the second build task was previously completed. The build task test engine controller 102 determines a new build task has been completed in the new home when the first, second, third, and fourth tests are passed. Further, the build task test engine controller 102 stores a new build task occurrence record indicating a new build task has been completed in the build task occurrence table 162.

Referring to FIG. 2, the build task notification controller 104 generates electronic messages that are sent to recipients who are interested in receiving notifications of completed build tasks. An electronic message can comprise either an email message or a text message for example. The build task notification controller 104 operably communicates with the relational database management system 92.

Referring to FIG. 1, the cell phone communication gateway 30 operably communicates with the Internet 20 and a cell phone 32. The cell phone communication gateway 30 receives electronic messages from the computer 24 and sends the electronic messages to the cell phone 32. The electronic messages comprise text messages. The cell phone 32 is owned by a recipient who is authorized to receive the electronic messages indicating completed build tasks associated with a new home.

The email communication gateway 34 operably communicates with the Internet 20 and a computer 36. The email communication gateway 34 receives electronic messages from the computer 24 and sends the electronic messages to the computer 36. The electronic messages comprise e-mail messages. The computer 36 is owned by a recipient who is authorized to receive the electronic messages indicating completed build tasks associated with a new home.

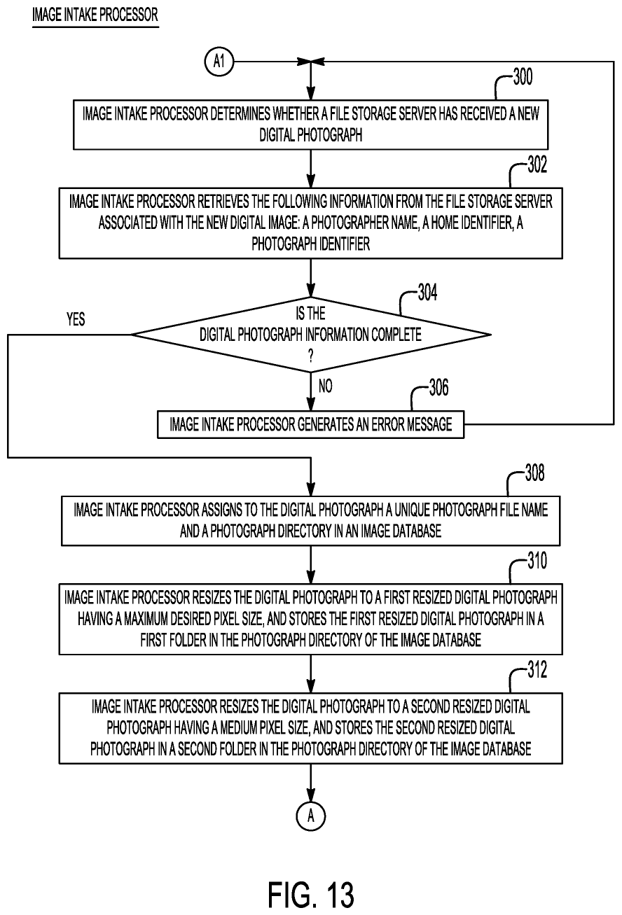

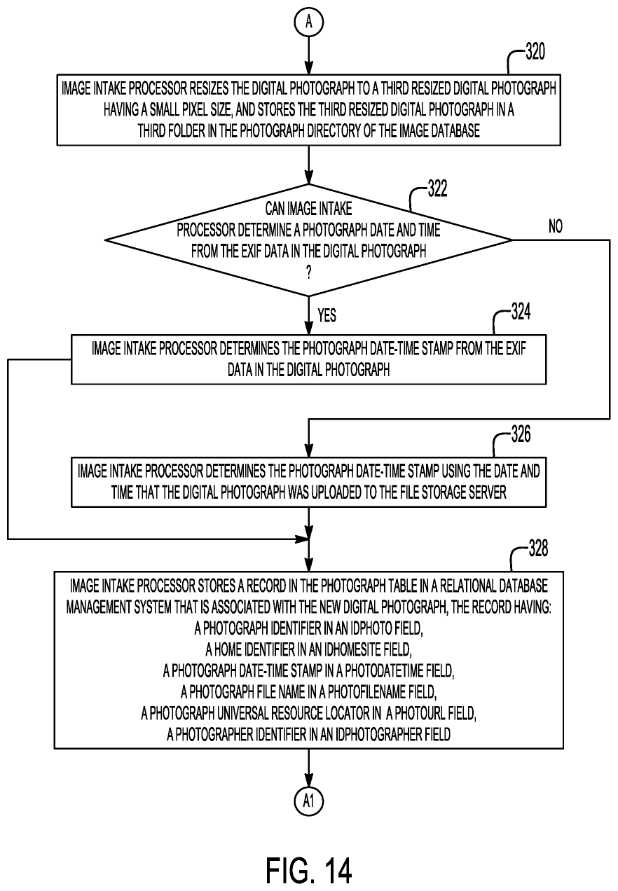

Referring to FIGS. 1, 2, 3, 13 and 14, a flowchart of a method implemented by the image intake processor 90 will now be explained.

At step 300, the image intake processor 90 determines whether a file storage server 22 has received a new digital photograph. After step 300, the method advances to step 302.

At step 302, the image intake processor 90 retrieves the following information from the file storage server 22 associated with the new digital image: a photographer name, a home identifier, a photograph identifier. After step 302, the method advances to step 304.

At step 304, the image intake processor 90 makes a determination as to whether the digital photograph information is complete. If the value of step 304 equals “yes”, the method advances to step 308. Otherwise, the method advances to step 306.

At step 306, the image intake processor 90 generates an error message. After step 306, the method returns to step 300.

Referring again to step 304, if the value of step 304 equals “yes”, the method advances to step 308. At step 308, the image intake processor 90 assigns to the digital photograph a unique photograph file name and a photograph directory in an image database 94. After step 308, the method advances to step 310.

At step 310, the image intake processor 90 resizes the digital photograph to a first resized digital photograph having a maximum desired pixel size, and stores the first resized digital photograph in a first folder in the photograph directory of the image database 94. After step 310, the method advances to step 312.

At step 312, the image intake processor 90 resizes the digital photograph to a second resized digital photograph having a medium pixel size, and stores the second resized digital photograph in a second folder in the photograph directory of the image database 94. After step 312, the method advances to step 320.

At step 320, the image intake processor 90 resizes the digital photograph to a third resized digital photograph having a small pixel size, and stores the third resized digital photograph in a third folder in the photograph directory of the image database 94. After step 320, the method advances to step 322.

At step 322, the image intake processor 90 makes a determination as to whether a photograph date and time can be obtained from the EXIF data in the digital photograph. If the value of step 322 equals “yes”, the method advances to step 324. Otherwise, the method advances to step 326.

At step 324, the image intake processor 90 determines the photograph date-time stamp from the EXIF data in the digital photograph. After step 324, the method advances to step 328.

Referring again to step 322, if the value of step 322 equals “no”, the method advances to step 326. At step 326, the image intake processor 90 determines the photograph date-time stamp using the date and time that the digital photograph was uploaded to the file storage server 22. After step 326, the method advances to step 328.

At step 328, the image intake processor 90 stores a record in a photograph table 140 in a relational database management system 92 that is associated with the new digital photograph. The record has: a unique photograph identifier in an IDPHOTO field, a home identifier in an IDHOMESITE field, a photograph date-time stamp in a PHOTODATETIME field, a photograph file name in a PHOTOFILENAME field, a photograph universal resource locator in a PHOTOURL field, a photographer identifier in an IDPHOTOGRAPHER field. After step 328, the method advances to step 300.

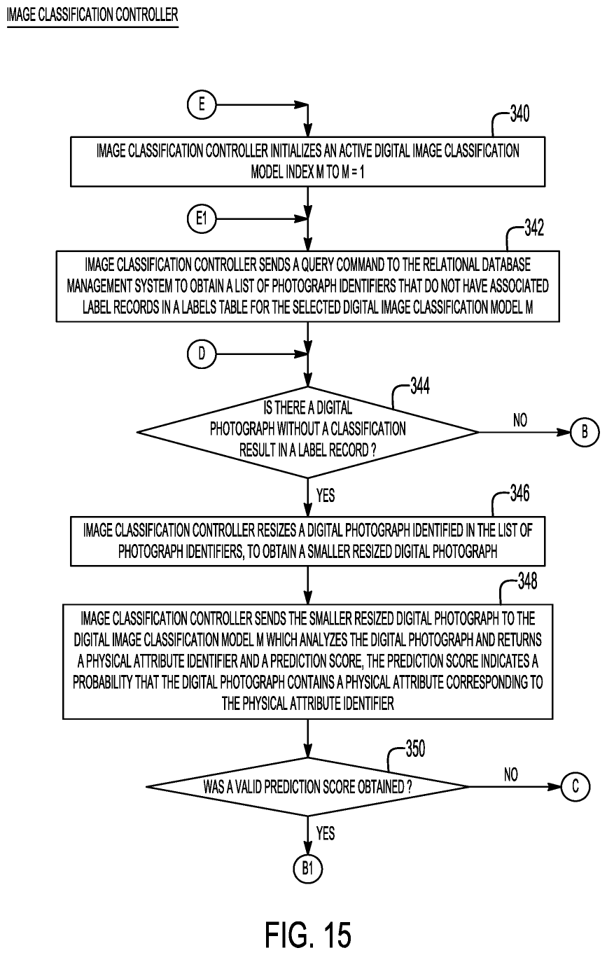

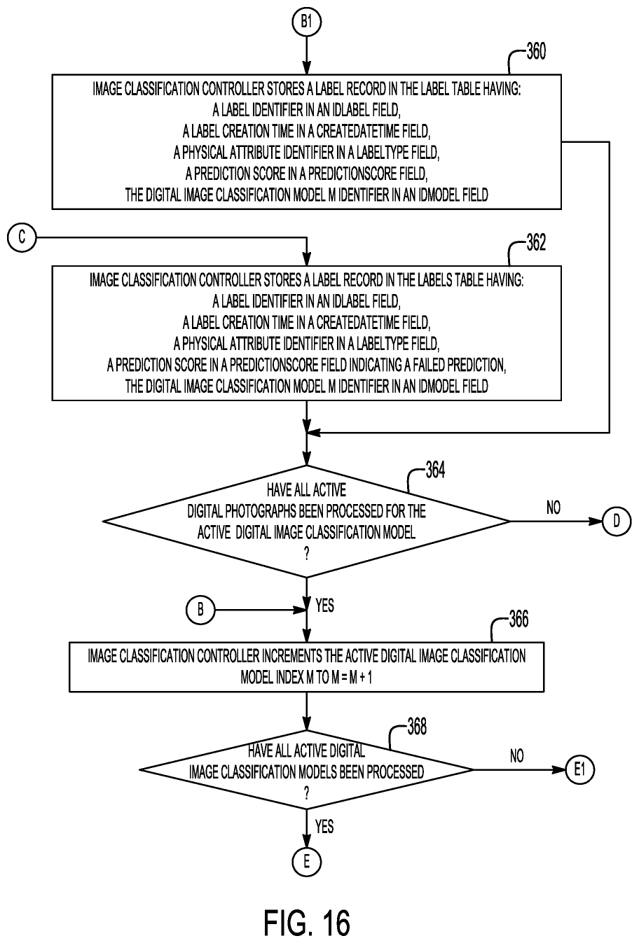

Referring to FIGS. 1, 2, 3, 15 and 16, a flowchart of a method implemented by the image classification controller 96 will now be explained.

At step 340, the image classification controller 96 initializes an active digital image classification model index M to M=1. After step 340, the method advances to step 342.

At step 342, the image classification controller 96 sends a query command to the relational database management system 92 to obtain a list of photograph identifiers that do not have associated label records in a labels table 150 for the selected digital image classification model. After step 342, the method advances to step 344.

At step 344, the image classification controller 96 makes a determination as to whether there is a digital photograph without a classification result (e.g., information in the LABELTYPE field) in a label record. If the value of step 344 equals “yes”, the method advances to step 346. Otherwise, the method advances to step 366.

At step 346, the image classification controller 96 resizes a digital photograph identified in the list of photograph identifiers, to obtain a smaller resized digital photograph. After step 346, the method advances to step 348.

At step 348, the image classification controller 96 sends the smaller resized digital photograph to the digital image classification model M which analyzes the digital photograph and returns a physical attribute identifier (e.g., information in the LABELTYPE field) and a prediction score. The prediction score indicates a probability that the digital photograph illustrates a physical attribute corresponding to the physical attribute identifier. After step 348, the method advances to step 350.

At step 350, image classification controller 96 makes a determination as to whether a valid prediction score was obtained. If the value of step 350 equals “yes”, the method advances to step 360. Otherwise, the method advances to step 362.

At step 360, the image classification controller 96 stores a label record in the label table having: a unique label identifier in an IDLABEL field, a label creation time in a CREATEDATETIME field, the physical attribute identifier in a LABELTYPE field, a prediction score in a PREDICTIONSCORE field, and the digital image classification model M identifier in an IDMODEL field. After step 360, the method advances to step 364.

Referring again to step 350, if the value of step 350 equals “no”, the method advances to step 362. At step 362, the image classification controller 96 stores a unique label record in the labels table 150 having: a label identifier in an IDLABEL field, a label creation time in a CREATEDATETIME field, the physical attribute identifier in a LABELTYPE field, a prediction score in a PREDICTIONSCORE field indicating a failed prediction, and the digital image classification model M identifier in an IDMODEL field. After step 362, the method advances to step 364.

At step 364, the image classification controller 96 makes a determination as to whether all of the active digital images been processed for the active digital image classification model. If the value of step 364 equals “yes”, the method advances to step 366. Otherwise, the method returns the step 344.

At step 366, the image classification controller 96 increments the active digital image classification model index M to M=M+1. After step 366, the method advances to step 368.

At step 368, the image classification controller 96 makes a determination as to whether all of the active digital image classification models have been processed. If the value step 368 equals “yes”, the method returns to step 340. Otherwise, the method returns to step 342.

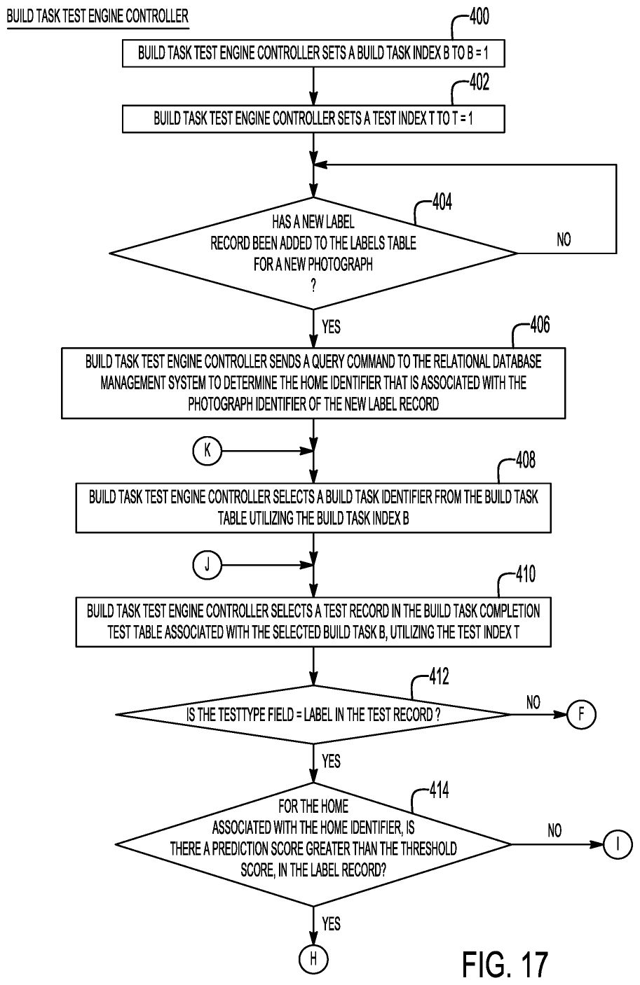

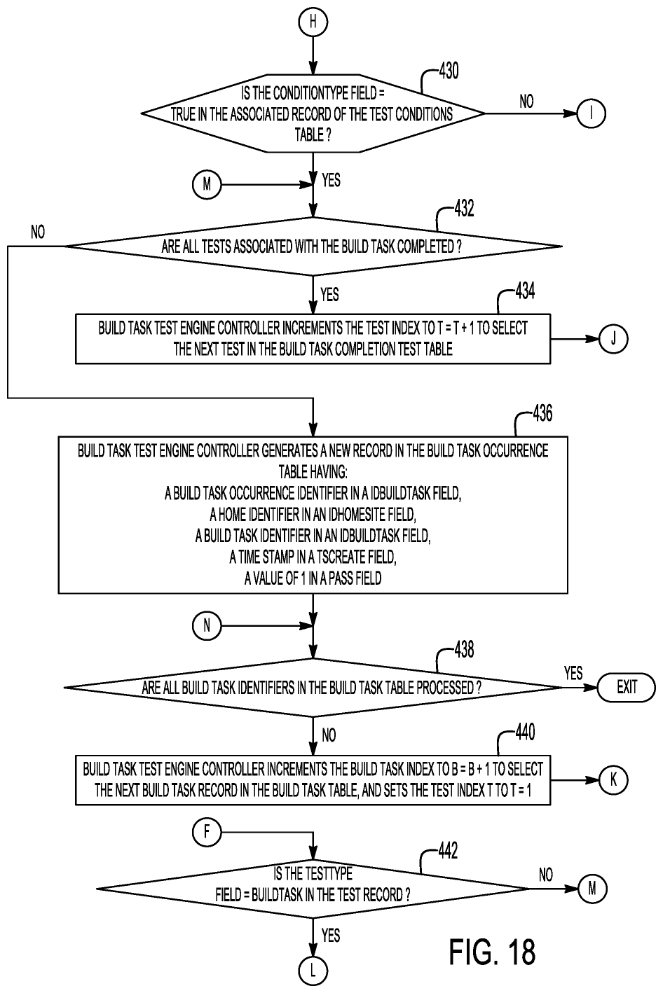

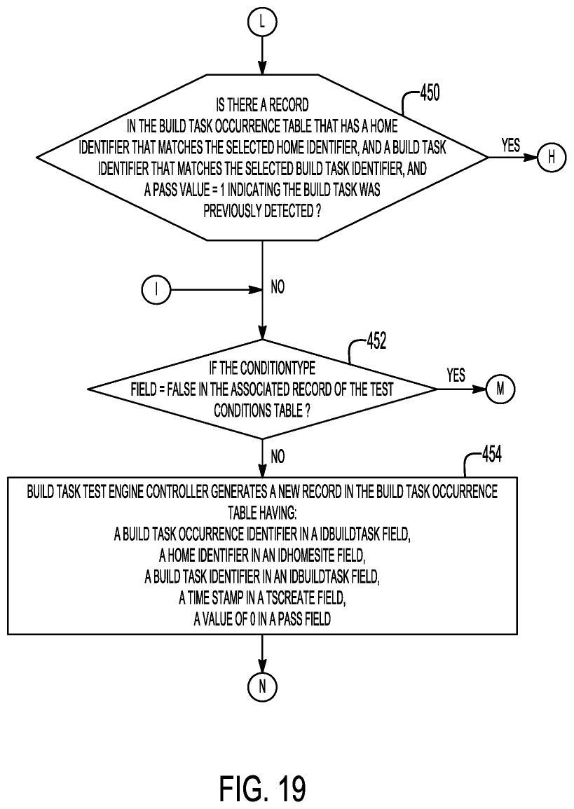

Referring to FIGS. 1, 2, 3 and 17-19, a flowchart of a method implemented by the build task test engine controller 102 will now be explained.

At step 400, the build task test engine controller 102 sets a build task index B to B=1. After step 400, the method advances to step 402.

At step 402, the build task test engine controller 102 sets a test index T to T=1. After step 402, the method advances to step 404.

At step 404, the build task test engine controller 102 makes a determination as to whether a new label record has been added to the labels table 150 for a new photograph. If the value of step 404 equals “yes”, the method advances to step 406. Otherwise, the method returns to step 404.

At step 406, the build task test engine controller 102 sends a query command to the relational database management system 92 to determine the home identifier that is associated with the photograph identifier of the new labels record. After step 406, the method advances to step 408.

At step 408, the build task test engine controller 102 selects a build task identifier from the build task table 160 utilizing the build task index B. After step 408, the method advances to step 410.

At step 410, the build task test engine controller 102 selects a test record in the build task completion test table 156 associated with the selected build task N, utilizing the test index T. After step 410, the method advances to step 412.

At step 412, the build task test engine controller 102 makes a determination as to whether the TESTTYPE field is equal to LABEL in the test record in the build task completion test table 156. If the value of step 412 equals “yes”, the method advances to step 414. Otherwise, the method advances to step 442.

At step 414, the build task test engine controller 102 makes a determination for the home associated with the home identifier, as to whether there is a prediction score greater than the threshold score in the labels record for the selected LABELTYPE. If the value of step 414 equals “yes”, the method advances to step 430. Otherwise, the method advances to step 452.

At step 430, the build task test engine controller 102 makes a determination as to whether the CONDITIONTYPE field equals “True” in the associated record of the test conditions table 158. If the value of step 430 equals “yes”, the method advances to step 432. Otherwise, the method advances to step 454.

At step 432, the build task test engine controller 102 makes a determination as to whether all tests associated with the build task are completed in the build task completion test table 156. If the value of step 432 equals “yes”, the method advances to step 436. Otherwise, the method advances to step 434.

At step 434, the build task test engine controller 102 increments the test index to T=T+1 to select the next test in the build task completion test table 156. After step 434, the method returns to step 410.

Referring again to step 432, if the value of step 432 equals “yes”, the method advances to step 436. At step 436, the build task test engine controller 102 generates a new record in the build task occurrence table 162 having: a unique build task occurrence identifier in a IDBUILDTASK field, a home identifier in an IDHOMESITE field, a build task identifier in an IDBUILDTASK field, a time stamp in a TSCREATE field, and a value of 1 in a PASS field. After step 436, the method advances to step 438.

At step 438, the build task test engine controller 102 makes a determination as to whether all build task identifiers in the build task table 160 have been processed. If the value of step 438 equals “no”, the method advances to step 440. Otherwise, the method is exited.

At step 440, the build task test engine controller 102 increments the build task index to B=B+1 to select the next build task record in the build task table 160, and sets the test index T to T=1. After step 440, the method returns to step 408.

Referring again to step 412, if the value of step 412 equals “no”, the method advances to step 442. At step 442, the build task test engine controller 102 makes a determination as to whether the TESTTYPE field equals BUILDTASK in a test record in the build task completion test table 156. If the value of step 442 equals “yes”, the method advances to step 450. Otherwise, the method returns to step 432.

At step 450, the build task test engine controller 102 makes a determination as to whether there is a record in the build task occurrence table 162 that has a home identifier that matches the selected home identifier, and a build task identifier that matches the selected build task identifier, and a pass value=1 indicating the build task was previously detected. If the value of step 450 equals “yes”, the method returns to step 430. Otherwise, the method advances to step 452.

At step 452, the build task test that you controller 104 makes a determination as to whether the CONDITIONTYPE field is equal to “False” in the record in the test conditions table 158. If the value of step 452 equals “yes”, the method returns to step 432. Otherwise, the method advances to step 454.

At step 454, the build task test engine controller 102 generates a new record in the build task occurrence table 162 having: a unique build task occurrence identifier in a IDBUILDTASK field, a home identifier in an IDHOMESITE field, a build task identifier in an IDBUILDTASK field, a time stamp in a TSCREATE field, a value of 0 in a PASS field indicating that the build task was not detected. After step 454, the method returns to step 438.

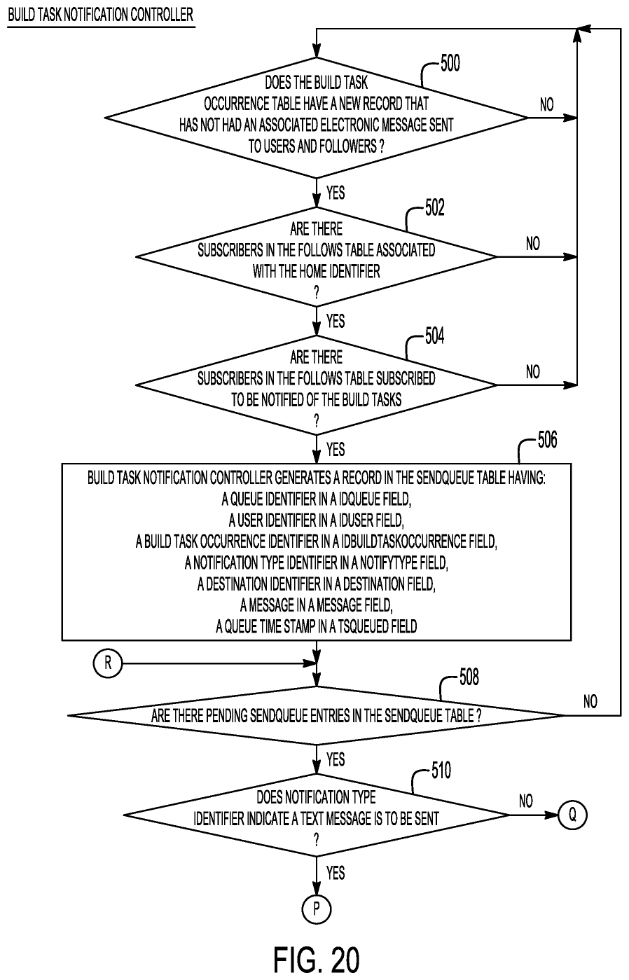

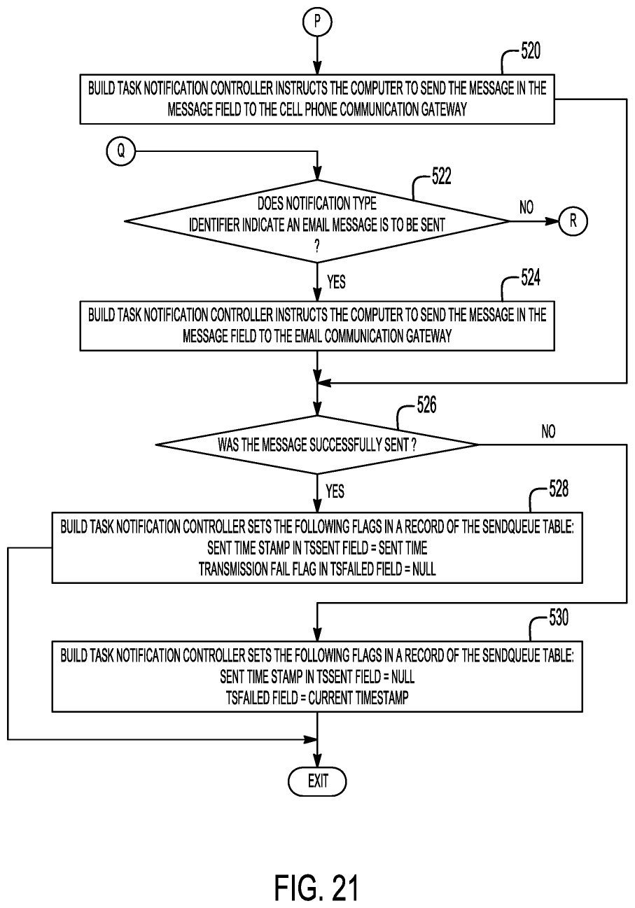

Referring to FIGS. 1, 2, 3 and 20-21, a flowchart of a method implemented by the build task notification controller 104 will now be explained.

At step 500, the build task notification controller 104 makes a determination as to whether the build task occurrence table 162 has a new record that has not had an associated electronic message sent to users and followers. If the value of step 500 equals “yes”, the method advances to step 502. Otherwise, the method returns to step 500.

At step 502, the build task notification controller 104 makes a determination as to whether there are subscribers in the follows table 164 associated with the home identifier. If the value of step 502 equals “yes”, the method advances to step 504. Otherwise, the method returns to step 500.

At step 504, the build task notification controller 104 makes a determination as to whether there the subscribers in the follows table 164 subscribed to be notified of the build tasks. If the value of step 504 equals “yes”, the method advances to step 506. Otherwise, the method returns to step 500.

At step 506, the build task notification controller 104 generates a record in the sendqueue table 166 having: a unique queue identifier in a IDQUEUE field, a user identifier in a IDUSER field, a build task occurrence identifier in a IDBUILDTASKOCCURENCE field, a notification type identifier in a NOTIFYTYPE field, a destination identifier in a DESTINATION field, a message in a MESSAGE field, a queue time stamp in a TSQUEUED field. After step 506, the method advances to step 508.

At step 508, the build task notification controller 104 makes a determination as to whether there are pending sendqueue entries in the sendqueue table 166. If the value of step 508 equals “yes”, the method advances to step 510. Otherwise, the method returns to step 500.

At step 510, the build task notification controller 104 makes a determination as to whether the notification type identifier indicates a text message is to be sent. If the value of step 510 equals “yes”, the method advances to step 520. Otherwise, the method advances to step 522.

At step 520, the build task notification controller 104 instructs the computer 24 to send the text message in the MESSAGE field to the cell phone number in the DESTINATION field via the cell phone communication gateway 30. After step 520, the method advances to step 526.

Referring again to step 510, if the value step 510 equals “no”, the method advances to step 522. At step 522, the build task notification controller 104 makes a determination as to whether the notification type identifier indicates an email message is to be sent. If the value of step 522 equals “yes”, the method advances to step 524. Otherwise, the method returns to step 508.

At step 524, the build task notification controller 104 instructs the computer 24 to send the email message in the MESSAGE field to the email address in the DESTINATION field via the email communication gateway 43. After step 524, the method advances to step 526.

At step 526, the build task notification controller 104 makes a determination as to whether the message was successfully sent. If the value of step 526 equals “yes”, the method advances to step 528. Otherwise, the method advances to step 530.

At step 528, the build task notification controller 104 sets the following flags in a record of the sendqueue table 166: sent time stamp in TSSENT field=sent time; transmission fail flag in TSFAILED field=null. After step 528, the method is exited.

Referring again to step 526, if the value step 526 equals “no”, the method advances to step 530. At step 530, the build task notification controller 104 sets the following flags in a record of the sendqueue table 166: sent time stamp in TSSENT field=null; transmission fail flag in TSFAILED field=the current timestamp. After step 530, the method is exited.

The system 10 for automatically detecting new home construction progress provides a substantial advantage over other systems. In particular, the system 10 utilizes a computer 24 with the build task test engine controller 102 that determines a build task that has been completed in the new home by analyzing a digital photograph and utilizing a physical attribute identifier, a prediction score, and build task completion tests. In particular, the computer 24 automatically analyzes the content of recent digital photographs of the home to determine present physical attribute identifiers, and utilizes the build task completion tests to review previously determined physical attribute identifiers and previously completed build tasks to reliably determine that a new build task has been completed. As a result, the computer 24 determines the completion of a new build task associated with a new home more efficiently and accurately than any known system. Further, the computer 24 automatically generates an electronic message that identifies the new build task has been completed.

While the claimed invention has been described in detail in connection with only a limited number of embodiments, it should be readily understood that the invention is not limited to such disclosed embodiments. Rather, the claimed invention can be modified to incorporate any number of variations, alterations, substitutions or equivalent arrangements not heretofore described, but which are commensurate with the spirit and scope of the invention. Additionally, while various embodiments of the claimed invention have been described, it is to be understood that aspects of the invention may include only some of the described embodiments. Accordingly, the claimed invention is not to be seen as limited by the foregoing description.

What is claimed is:

1. A system for automatically detecting new home construction progress, comprising:
at least one computer having an image intake processor, an image classification controller, a build task test engine controller, and a build task notification controller;
the image intake processor receiving a digital photograph of a new home and photograph attribute data associated with the digital photograph; the photograph attribute data including a photograph identifier, and a home identifier for the new home;
the image classification controller sending the digital photograph to a first digital image classification model which determines a first prediction score associated with a first physical attribute identifier, the first prediction score indicates a probability that the digital photograph illustrates a first physical attribute corresponding to the first physical attribute identifier;
the build task test engine controller determining a first build task that has been completed in the new home using the first physical attribute identifier, the first prediction score, and first build task completion tests; and
the build task notification controller generating an electronic message that indicates the first build task that has been completed.

2. The system of claim 1, wherein:
the image intake processor receiving the digital photograph of the new home and the photograph attribute data from a file storage server;
the image intake processor storing the digital photograph in an image database; and
the image intake processor storing the photograph attribute data in a record in a photograph table.

3. The system of claim 2, wherein the photograph attribute data includes a photograph identifier, the home identifier, a photograph date-time stamp, and a photographer identifier.

4. The system of claim 1, wherein:
the image classification controller storing the photograph identifier, the first physical attribute identifier, and the first prediction score in a record in a label table.

5. The system of claim 1, wherein:
the image classification controller sending the digital photograph to a second digital image classification model which determines a second prediction score associated with a second physical attribute identifier, the second prediction score indicates a probability that the digital photograph illustrates a second physical attribute corresponding to the second physical attribute identifier.

6. The system of claim 1, wherein:
the first physical attribute identifier includes at least one of interior, exterior, kitchen, cabinets, flooring, windows, debris, and grass.

7. The system of claim 1, wherein:
the first build task completion tests comprises a first test;
the build task test engine controller performing the first test associated with the first physical attribute identifier by comparing the first prediction score to a first threshold score, the first test being passed when the first prediction score being greater than the first threshold score.

8. The system of claim 7, wherein:
the first build task completion tests further comprises a second test;
the build task test engine controller performing the second test to determine whether a build task occurrence table has a first build task occurrence record indicating a second build task was previously completed, the second test being passed when the build task occurrence table has the first build task occurrence record indicating the second build task was previously completed.

9. The system of claim 8, wherein:
the first build task completion tests further comprises a third test;
the build task test engine controller performing the third test associated with a second physical attribute identifier by comparing a second prediction score to a second threshold score, the third test being passed when the second prediction score being greater than the second threshold score.

10. The system of claim 9, wherein:
the first build task completion tests further comprises a fourth test;
the build task test engine controller performing the fourth test to determine whether the build task occurrence table has a second build task occurrence record indicating the first build task was previously completed, the fourth test being passed when the build task occurrence table does not have the second build task occurrence record indicating the first build task was previously completed.

11. The system of claim 10, wherein:
the build task test engine controller determining the first build task has been completed in the new home when the first, second, third, and fourth tests are passed.

12. The system of claim 8, wherein:
the build task test engine controller determining the first build task has been completed in the new home when the first and second tests are passed.

13. The system of claim 12, wherein:
the build task test engine controller storing the first build task occurrence record indicating the first build task has been completed in the build task occurrence table.

14. The system of claim 13, wherein:
the build task notification controller generating the electronic message that identifies the first build task that has been completed, when the first build task occurrence record is stored in the build task occurrence table.

15. The system of claim 14, wherein the electronic message comprises an email message or a text message.

16. The system of claim 14, wherein the build task notification controller sends the electronic message to a communication gateway device.
